(19) United States
(12) Patent Application Publication
(10) Pub. No.: US 2005/0155011 A1
(43) Pub. Date: Jul. 14, 2005

(54) Method and system for restricting access in a distributed job environment

(76) Inventors: Stephan Heik, Wiesloch (DE); Jochen Mueller, Heidelberg (DE); Guenter Zachmann, Rauenberg (DE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/756,021

(22) Filed: Jan. 12, 2004

(51) Int. Cl. G06F 9/44

(52) U.S. Cl. 717/100

(57) ABSTRACT

A system and method of providing logical locking to shared resources in a distributed Java environment. A plurality of Java virtual machines (JVMs) share a lock server. Each JVM includes a lock manager to interact with the lock server. The lock server provides a centralized source of logical locks for shared resources and maintains a lock table of those locks in a shared memory.

### BACKGROUND

1. Field of the Invention

Embodiments of the invention relate generally to a field of data processing systems. More particularly, embodiments of the invention relate to access control to facilitate editing of data in a distributed environment.

2. Background

Java, with its platform independence, has become the development environment of choice in many circles. With the advent of Java 2 Enterprise Edition Specification v1.4, published on Jul. 12, 2002 (the J2EE Standard), Java has made inroads into the enterprise environment. However, to deployment of Java in large scale distributed systems, has lead to unique problems including access control. In distributed systems, in particular, those that use a shared database between the various nodes of the system, it is important to control access among the nodes so that inconsistent modifications do not get propagated into the shared database. Thus, it is particularly important in a context of write access to prevent other users from concurrently obtaining such write access.

### SUMMARY

A system and method to provide access control to share resources in a distributed Java based system is disclosed. A plurality of Java virtual machines (JVMs) each have a lock manager to interact with a shared lock server. The shared lock server to allocate logical database locks among the JVMs. The lock server maintains a lock table in shared memory recording the allocation of the logical database locks.

### BRIEF DESCRIPTION OF THE DRAWINGS

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a block diagram of a distributed system in one embodiment of the invention.

FIG. 2 is a fundamental modeling concept diagram of interaction within lock manager and lock server in one embodiment of the invention.

### DETAILED DESCRIPTION

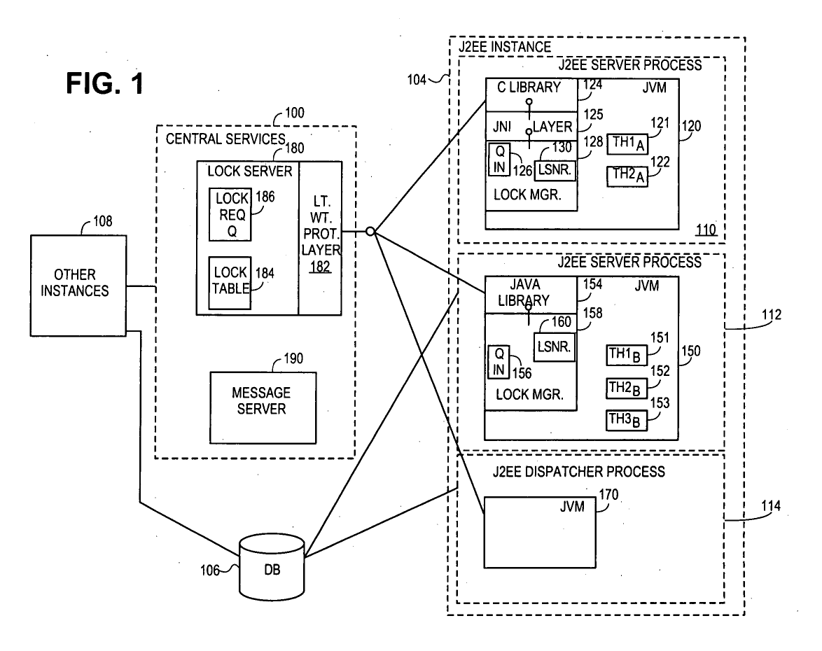

FIG. 1 is a block diagram of a distributed system in one embodiment of the invention. A central services node 100, provides services to one or more instances, such as Java 2 Enterprise Edition (J2EE) instance 104 and other instances 108. Other instances 108 may be additional J2EEE instances or may be instances created using a different paradigm. As used herein, each “instance” is a unit in the distributed system (also referred to as a cluster), which can be started, stopped and monitored separately. An instance typically contains at least one server process e.g., process server 110 or 112. More commonly, an instance includes a dispatcher 114 and more than one server process 110, 112. It is also contemplated that more than one dispatcher may reside in a single instance.

In one embodiment, each instance runs on one physical server, but more than one instance may run on single physical server. In one embodiment, an instance may be identified within the cluster by a system identification number and an instance number. In one embodiment, the central services node is a special example of a J2EE instance. Central services node 100 includes lock server 180 and a message server 190. Message server 190 registers all active server and dispatcher processes within the cluster. When the server goes down, e.g., crashes or otherwise shuts down, message server is aware of the shutdown and notifies the lock server 180. This notification is independent of other lock requests that may be occurring. Also shared between the instances 104, 108 is database 106.

Lock server 180 includes a lightweight protocol layer 182, which provides an interface for communication with other processes within the cluster. Also in lock server 180 is a lock table 184 retained in shared memory. In some embodiments, a lock requested queue 186 might also be provided. Lock request queue 186 permits wait on locking to performed by the lock server 180. If no wait on locking is permitted and a process requests a lock for data for which a lock already exists in the lock table 184, lock server 180 generates an exception and sends it back to the requesting process. Thus, when a request is received through the lightweight protocol layer 182, the lock server checks lock table 184 and determines whether the requested lock is permitted based on those locks already in existence. If the lock is available, lock server 180 adds an entry to lock table 184 and grants the lock to the requesting process. Embodiments in which wait on locking is supported, if the lock is not available, the request is queued in lock requested queue 186. In one embodiment, lock requested queue may be implemented with a semaphore or a similar synchronization object.

Additionally, if lock server 180 receives notification from message server 190 that a process has become inactive, lock server 180 checks the lock table 184 for entries owned by that process, clears the entries and releases all corresponding locks. This prevents deadlock conditions where a server process crashes or shuts down with active locks and makes that (previously locked) data available to other processors in the system.

J2EE server process 110 hosts a Java virtual machine (JVM) 120, which may have threads 121 and 122 executing therein. Threads 121 and 122 may correspond to client activity, which may be directed over a distributed network (not shown) such as the Internet. Commonly, the client directing a threads activity may be web browser. Clients can communicate with the server process using a hypertext transfer protocol (http). When one of the threads executing in JVM 120 wishes to obtain read or write access to data within database 106, the thread requests the lock manager 128 within JVM 120 obtain a read or write lock as the case may be for that data. Notably, within a cluster, a read lock can be shared while a write lock should be exclusive. A thread may then register with listener agent 130. In one embodiment, listener agent 130 may be a dedicated thread that watches the bound queue 126 for responses to the lock requests sent by the lock manager 128. Lock manager 128 sends requests using the Java native interface (JNI) layer 125 through C library 124 to the lock server 180 on the central services node 100.

In one embodiment, the lock manager 128 provides a basic application programming interface (API) including the following calls: lock (owner, argument, modus); unlock(owner, argument, modus) and unlockall(owner). In this API, owner is the transaction to which the lock applies. The transaction may be a business transaction or a technical transaction. The argument identifies what data is to be locked and modus indicates whether the lock is to be a read lock or a write lock. As noted above, read locks may be shared, while write locks must be exclusive.

In some embodiments, the lock manager 128 may supply additional API for application locking and table locking. With the basic API above as a wrapper around the more restrictive locking types. In this context, additional parameter (lifetime) is required in the lock call. Lifetime is typically a user session or transaction. In the context of table locking, the argument becomes an identification of the table and the columns to be locked. In some embodiments wait on locking may be supported. In such embodiment, the lock call may specify an additional “time out” parameter. The time out parameter specifies a minimum amount of time the owner will wait to receive the lock. If the lock does not become available before the time out parameter is exhausted, the owner will not obtain the lock.

J2EE server process 112 hosts JVM 150. Shown as having a plurality of threads 151-153 executing therein. Locking manager 158 and JVM 150 includes a Java library 154, which permits direct communication with locking server 180 without going through a JNI layer or making JNI calls. Additionally, because the Java library 154 is platform independent, it is not necessary to list it on every possible deployment platform. In one embodiment, Java library 154 is thread safe and may provide multiple remote connections to the lock server, which can be used in parallel by a plurality of threads 151-153. However, to conserve resources, in one embodiment, the number of connections is limited to, for example, a single connection. In one embodiment, the lock server 180 permits assynchronous communication over a single connection. This permits multiple threads, e.g. threads 151-153 to pass requests over a single connection without waiting for the response. Moreover, the response may arrive in a different order than the requests were sent. To match requests and responses to the Java library 154, provide a requesting thread, e.g. thread 151 with an identification tag to tag its requests. The thread 151 may then be given exclusive access to the send interface. The thread 151 sends its request and registers with an existing agent to notify the thread 151 if a response with the same identification tag is returned. After registration, the thread releases the send interface so it will be free for use by any other thread, e.g. threads 152, 153. Any number of other threads may send requests similarly. Once a response (with the identification tag corresponding to thread 151) is received, the listing agent notifies the thread 151 and passes the response to thread 151.

Listener 160 is provided similar to listener 130 described above. Inbound queue 156 is provided to queue incoming responses from lock server 180. JVM 170 in J2EE dispatcher process 114 may be analogous to either JVM 120 or JVM 150. In some embodiments, the locking manager in the JVMs hosted within all processes of a particular instance user a same library format to communicate with lock server 180. Thus, all server processes may include a lock manager with a JNI layer in a C library or just a Java library.

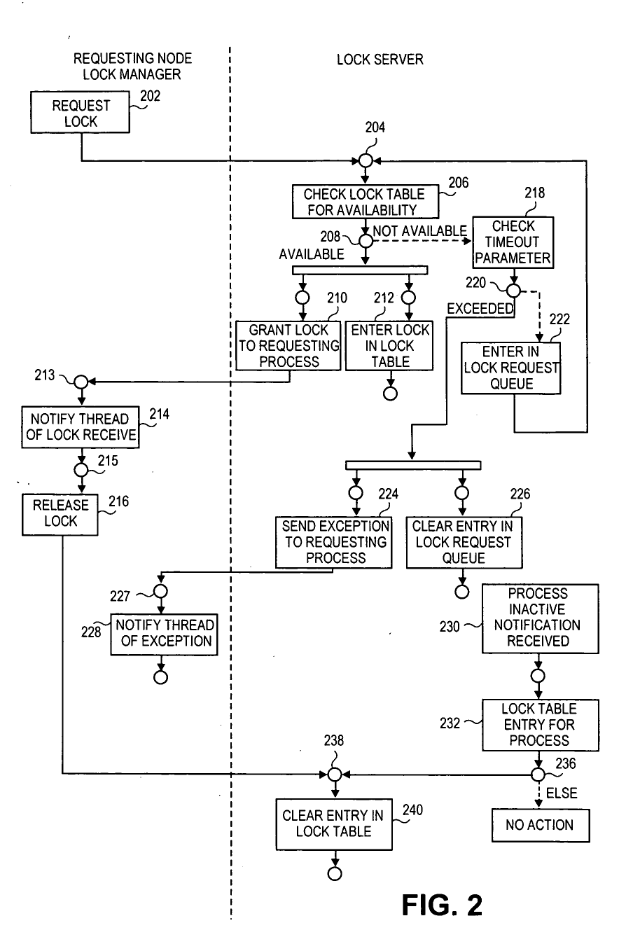

FIG. 2 is a fundamental modeling concept diagram of interaction within lock manager and lock server in one embodiment of the invention. The lock manager generates a request for a lock at 202. At 204, the request is received by the lock server. The lock server checks for the availability of the lock at 206. In one embodiment, lock server reviews the type of lock, e.g., exclusive or non-exclusive requested and checks the lock table, which may be stored in shared memory, to discern if the lock is available. At 208, if the lock is available, the lock server grants the lock to the requesting process at 210 and enters the lock requested into the lock table at 212. At 213, the granted lock is received by requesting node's lock manager and queued in the inbound queue. At 214, a requesting thread is notified that the lock has been received. At node 215, the thread conducts whatever transaction necessitated the lock. After the transaction is complete, the lock is released at 216.

If instead at node 208, the lock was not available, the timeout parameter within the call may be checked if wait on locking is supported. If wait on locking is not supported the timeout parameter can be thought of as zero. At node 220, if the timeout parameter has not been exceeded, the lock request is entered into the lock request queue and continues to wait for lock availability until the lock is available or the timeout parameter is exceeded. When a timeout parameter is exceeded, an exception is sent to the requesting lock manager at 224 and the lock entry is cleared from the lock request queue at 226. At 227, the exception is received in the inbound queue of the requesting lock manager. At 228, requesting thread is notified of the exception.

When a process becomes inactive e.g., crashes or shuts down, Asynchronis with the general lock request sequencing lock server receive a notification that a process has become inactive at 230. This message may be provided by the message server, as noted above. Responsive to such notification, the lock server checks the lock table for lock entries associated with the now inactive process at 232. At node 234, if there is no lock registered for inactive process, no action is taken at 236. The release lock request (sent at 216) is received by a lock server at node 238. Alternatively, if lock entries have been identified for an inactive process the lock server internally generates a release lock event. In either case, lock server clears a corresponding entry or entries the lock table at 240. The lock for that data is then available to the next requesting process.

Elements of the present invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or other type of machine-readable media suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

1. A system comprising:
a plurality of Java virtual machines JVMs) each having a lock manager; and
a lock server shared by the plurality of JVMs, the lock server to allocate logical database locks to the JVM's and having a shared memory storing a lock table to maintain a record of the allocation.

2. The system of claim 1 when the locking manager comprises a Java library to permit direct communication to the lock server.

3. The system of claim 1 wherein the locking manager comprises:
a java native interface (JNI) layer; and
a C library.

4. The system of claim 1 wherein the locking manager comprises:
a listener; and
an inbound queue.

5. The system of claim 1 wherein the lock server comprises:
a lock requested queue.

6. The system of claim 1 wherein the lock server comprises a light weight protocol.

7. The system of claim 1 wherein the plurality of JVM's are hosted inside a plurality of Java 2 Enterprise Edition (J2EE) server processes.

8. The system of claim 7 further comprises:
a database shared by the plurality of server processes.

9. A method comprising:
receiving a request for a lock from a thread executing in a Java virtual machine (JVM)
requesting the lock from a lock server;
receiving an exception if the lock is not available; and
receiving the lock if the lock is available.

10. The method of claim 9 further comprising:
registering the thread with a listener, the listener to watch an inbound queue for the lock or the exception, and to notify the thread of receipt of the lock or the exception.

11. The method of claim 9 wherein requesting the lock comprises:
supplying a timeout parameter to indicate a maximum wait to obtain the lock.

12. The method of claim 11 further comprising:
timing out the request when the maximum wait has been exceeded.

13. The method of claim 9 further comprising:
hosting the JVM inside a Java 2 Enterprise Edition (J2EE) server process.

14. A method comprising:
receiving a request for a lock from a server process;
checking a lock table in shared memory to determine an availability of the lock;
entering the lock in the lock table if the lock is available; and
granting the lock to the server process if the lock is available.

15. The method of claim 15 further comprising:
entering the request in a lock requested queue if the lock is not currently available.

16. The method of claim 15 further comprising:
releasing all locks granted to the server process if the server process crashes or shuts down.

17. The method of claim 17 when releasing comprises:
clearing an entry for the lock table corresponding to the server process.

18. The method of claim 16 further comprising:
removing the request from the lock requested queue if a time out occurs before the lock becomes available; and
granting the lock to the server process if the lock becomes available before a time out occurs.

19. A computer readable storage media containing executable computer program instructions which when executed cause a digital processing system to perform a method comprising:
receiving a request for a lock from a server process;
checking a lock table in shared memory to determine an availability of the lock;
entering the lock in the lock table if the lock is available; and
granting the lock to the server process if the lock is available.

20. The computer readable storage media of claim 20 which when executed cause a digital processing system to perform a method further comprising:
entering the request in a lock requested queue if the lock is not currently available.

21. The computer readable storage media of claim 20 which when executed cause a digital processing system to perform a method further comprising:
releasing all locks granted to the server process if the server process crashes or shuts down.

22. The computer readable storage media of claim 22 which when executed cause a digital processing system to perform a method further comprising:
clearing an entry for the lock table corresponding to the server process.

23. The computer readable storage media of claim 21 which when executed cause a digital processing system to perform a method further comprising:
removing the request from the lock requested queue if a time out occurs before the lock becomes available; and
granting the lock to the server process if the lock becomes available before a time out occurs.

24. A computer readable storage media containing executable computer program instructions which when executed cause a digital processing system to perform a method comprising:
receiving a request for a lock from a thread executing in a Java virtual machine (JVM)
requesting the lock from a lock server;
receiving an exception if the lock is not available; and
receiving the lock if the lock is available

25. The computer readable storage media of claim 25 which when executed cause a digital processing system to perform a method further comprising:
registering the thread with a listener, the listener to watch an inbound queue for the lock or the exception, and to notify the thread of receipt of the lock or the exception.

26. The computer readable storage media of claim 25 which when executed cause a digital processing system to perform a method further comprising:
supplying a timeout parameter to indicate a maximum wait to obtain the lock.

27. The computer readable storage media of claim 25 which when executed cause a digital processing system to perform a method further comprising:
timing out the request when the maximum wait has been exceeded.
